(19) United States
(12) Patent Application Publication
(10) Pub. No.: US 2013/0164995 A1
(43) Pub. Date: Jun. 27, 2013

(54) TELEVISION RECEIVER AND ELECTRONIC DEVICE

(71) Applicants: Satoru YASUI, Tokyo (JP); Tsuyoshi KOZAI, Tokyo (JP)

(72) Inventors: Satoru YASUI, Tokyo (JP); Tsuyoshi KOZAI, Tokyo (JP)

(73) Assignee: KABUSHIKI KAISHA TOSHIBA, Tokyo (JP)

(21) Appl. No.: 13/609,611

(22) Filed: Sep. 11, 2012

(30) Foreign Application Priority Data
Dec. 27, 2011 (JP) 2011-286614

(51) Int. Cl. H01R 13/04

(52) U.S. Cl. 439/692

(57) ABSTRACT

According to one embodiment, a television receiver includes: housing; display; circuit board; and connector. The connector includes: an insulating member; a plurality of terminal members; a first terminal portion; and a plurality of second terminal portions. The insulating member includes an insertion portion into which an external connector is inserted. The terminal members are provided in parallel with the insulating member in a direction intersecting with a direction in which the external connector is inserted into the insertion portion. The first terminal portion is included in each of the terminal members, and electrically connected to the external connector in the insertion portion. The second terminal portions are included in each of the terminal members, electrically connected to the first terminal portion, and point different directions from each other. One of the second terminal portions of each of the terminal members is electrically connected to the circuit board.

### CROSS-REFERENCE TO RELATED APPLICATIONS

This application is based upon and claims the benefit of priority from Japanese Patent Application No. 2011-286614, filed on Dec. 27, 2011, the entire contents of which are incorporated herein by reference.

### FIELD

Embodiments described herein relate generally to a television receiver and an electronic device.

### BACKGROUND

Conventionally known is a television receiver or an electronic device having a housing that houses a circuit board on which a connector is implemented.

Examples of such a connector include a straight connector into which a counterpart connector is inserted in a direction perpendicular to the mounting surface of the circuit board, and a right angle connector into which a counterpart connector is inserted in a direction along the mounting surface of the circuit board.

It has been desired to improve an implementation efficiency of a circuit board in a television receiver or an electronic device.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary front view of a television receiver according to a first embodiment;

FIG. 2 is an exemplary side view of the television receiver in the first embodiment;

FIG. 3 is an exemplary schematic diagram illustrating a cross section taken along the line III-III in FIG. 1, in the first embodiment;

FIG. 4 is an exemplary schematic diagram illustrating a cross section taken along the line IV-IV in FIG. 1, in the first embodiment;

FIG. 5 is an exemplary perspective view of a circuit board and a connector in the television receiver in the first embodiment;

FIG. 6 is another exemplary perspective view of the circuit board and the connector in the television receiver in the first embodiment;

FIG. 7 is an exemplary cross-sectional view taken along the line VII-VII in FIG. 5, in the first embodiment;

FIG. 8 is an exemplary cross-sectional view taken along the line VIII-VIII in FIG. 5, in the first embodiment;

FIG. 9 is an exemplary cross-sectional view taken along the line IX-IX in FIG. 6, in the first embodiment;

FIG. 10 is an exemplary cross-sectional view taken along the line X-X in FIG. 6, in the first embodiment;

FIG. 11 is an exemplary cross-sectional view of a television receiver as viewed from a position equivalent to FIG. 7, according to a modification of the first embodiment;

FIG. 12 is an exemplary cross-sectional view of a television receiver as viewed from a position equivalent to FIG. 7, according to a second embodiment;

FIG. 13 is an exemplary cross-sectional view of the television receiver as viewed from a position equivalent to FIG. 8, in the second embodiment;

FIG. 14 is an exemplary cross-sectional view of a television receiver as viewed from a position equivalent to FIG. 7, according to a modification of the second embodiment;

FIG. 15 is an exemplary cross-sectional view of the television receiver as viewed from a position equivalent to FIG. 8, in the modification of the second embodiment;

FIG. 16 is an exemplary perspective view of a circuit board and a connector of a television receiver according to a third embodiment;

FIG. 17 is an exemplary perspective view of an electronic device according to a fourth embodiment;

FIG. 18 is an exemplary rear view of the electronic device in the fourth embodiment;

FIG. 19 is an exemplary plan view (rear view) of an internal structure of the electronic device comprising a first member, in the fourth embodiment;

FIG. 20 is an exemplary plan view (front view) of an internal structure of the electronic device comprising a second member in the fourth embodiment;

FIG. 21 is an exemplary plan view (front view) illustrating the example of the internal structure of the electronic device comprising the second member, with a cover placed on the circuit board, in the fourth embodiment; and

FIG. 22 is an exemplary perspective view of an electronic device according to a fifth embodiment.

### DETAILED DESCRIPTION

In general, according to one embodiment, a television receiver comprises: a housing; a display; a circuit board; and a connector. The display is in the housing and comprises a display surface and a rear surface. The circuit board is in the housing and configured to be positioned on a side of the rear surface of the display, and is to be housed in the housing. The connector is in the housing and configured to be electrically connected to the circuit board. An external connector is connected to the connector. The connector comprises: an insulating member; a plurality of terminal members; a first terminal portion; and a plurality of second terminal portions. The insulating member comprises an insertion portion into which the external connector is inserted. The terminal members are configured to be provided in parallel with the insulating member in a direction intersecting with a direction in which the external connector is inserted into the insertion portion. The first terminal portion is included in each of the terminal members, and is configured to be electrically connected to the external connector in the insertion portion. The second terminal portions are included in each of the terminal members, is configured to be electrically connected to the first terminal portion, and is configured to point different directions from each other. The one of the second terminal portions of each of the terminal members is configured to be electrically connected to the circuit board.

In exemplary embodiments described below, common elements are comprised. Therefore, in explanations below, the same reference numerals are assigned to the same elements, and redundant explanations thereof are partially omitted. In addition, in each of the drawings, directions (an X direction, a Y direction, and a Z direction) are illustrated for convenience. The X direction corresponds to the longitudinal direction of a display surface 4a of in a front view. The Y direction corresponds to the short side direction of the display surface 4a in the front view. The Z direction corresponds to the front-back direction of the display surface 4a (depth direction, the thickness direction of a housing 3A) in the front view. The X direction, the Y direction, and the Z direction perpendicularly intersect each other.

In the embodiments described below, explained as an example is an electronic device configured as a television receiver or a personal computer; however, the electronic device according to the embodiments is not limited thereto. For example, the electronic device according to the embodiment may be various electronic devices such as a smartphone, a smartbook, a cellular phone, a personal digital assistant (PDA), a video display device, and a video phone.

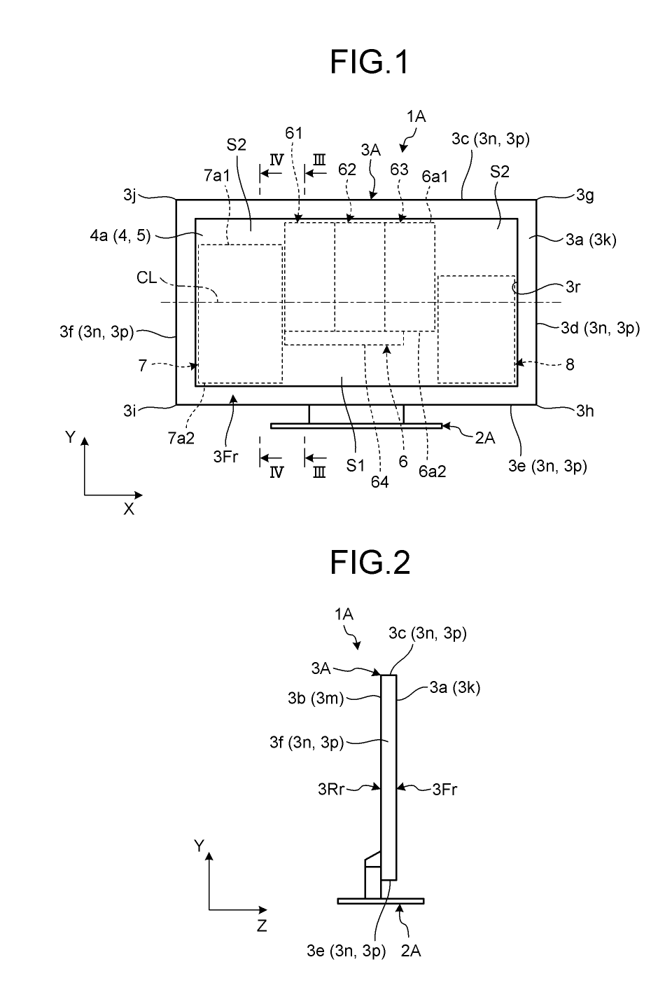

A television receiver 1A that is an example of an electronic device according to a first embodiment comprises a support 2A (a supporting portion, a station, a stand) and the housing 3A, as illustrated in FIGS. 1 and 2. Specifically, the support 2A is placed on a setting area such as a desk, a shelf, and a table (a setting surface not illustrated), and supports the housing 3A at an upright position. To support the housing 3A, the support 2A may be fixed to the housing 3A, or may be movable (rotatable, slidable) with respect to the housing 3A. The support 2A of the housing 3A may be moved (rotated) by being tilted, swiveled, or pivoted, for example.

In the first embodiment, as an example, as may be understood from FIG. 1, the housing 3A has an external appearance of a rectangular shape (in the first embodiment, an oblong shape, as an example) in the front view (and the rear view). The housing 3A is also a cuboid shape that is thin and flat in the front-back direction (the thickness direction of the housing 3A, the Z direction), as illustrated in FIG. 2. The housing 3A comprises a front surface 3a (a frontal surface, a surface, a surface portion) and a rear surface 3b (a back surface, a surface, a surface portion) located opposite the front surface 3a. The front surface 3a and the rear surface 3b are laid approximately in parallel (in the first embodiment, in parallel, as an example). The housing 3A also comprises four ends 3c to 3f (sides, edge portions) and four corners 3g to 3j (pointed portions, curved portions, ends) in the front view, as illustrated in FIG. 1. The ends 3c and 3e are examples of longer sides. The ends 3d and 3f are examples of shorter sides.

The housing 3A comprises a wall 3k (a portion, a plate, a frame, a front wall, a frontal wall, a top wall) including the front surface 3a, and a wall 3m (a portion, a plate, a rear wall, a back wall, a bottom wall, a second wall) including the rear surface 3b. Each of the walls 3k and 3m has a rectangular shape (in the first embodiment, an oblong shape, as an example). The wall 3k also has a frame-like shape, and the wall 3m has a plate-like shape. The housing 3A comprises four walls 3n (portions, plates, side walls, end walls, standing walls, stretched portions, first walls) each of which includes a side surface 3p (a surface, a circumferential surface) and stretches across the wall 3k and the wall 3m. An opening 3r having a rectangular shape is formed on the wall 3k.

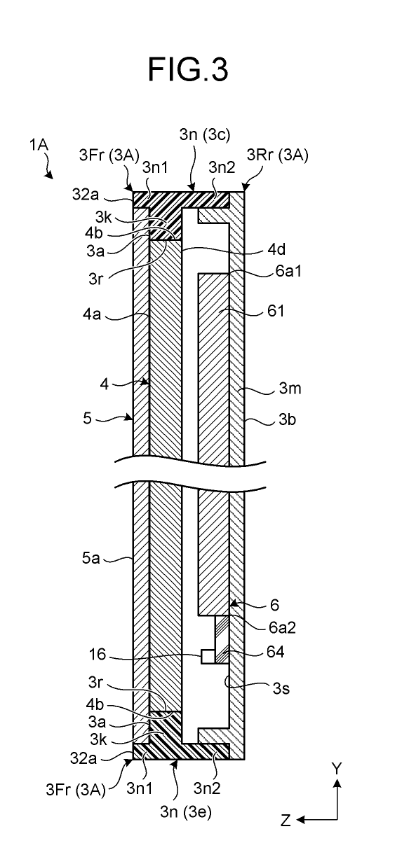

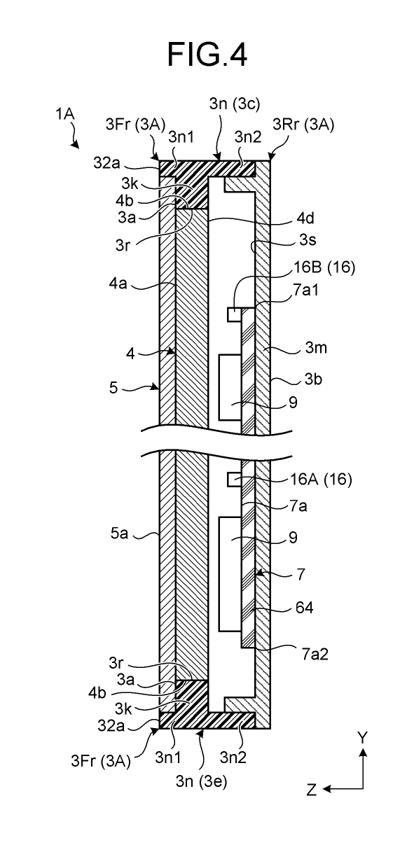

The housing 3A is made up from a combination of a plurality of parts (divided portions, members). The housing 3A comprises a first member 3Fr (a first portion, a front side member, a cover, a bezel, a frame) including at least the wall 3k, and a second member 3Rr (a second portion, a rear side member, a base, a bottom, a plate) at least including the wall 3m, as an example. In the first embodiment, the walls 3n are configured as a portion of the first member 3Fr. Each of the walls 3n stretches across an end 3n1 (one end, a front end, the front surface 3a) located on the side of the opening 3r in the thickness direction of the housing 3A, and an end 3n2 (the other end, a rear end, the rear surface 3b) located opposite the end 3n1 and covers the circumference (a side surface 4b, see FIGS. 3 and 4) of a display device 4.

In the first embodiment, as an example, the first member 3Fr is made of a synthetic resin material, and the second member 3Rr is made of a metallic material. Because the walls 3n are included in the first member 3Fr, as mentioned earlier, if the first member 3Fr is to be made of a metallic material having a higher specific gravity than that of a synthetic resin material, the housing 3A could become heavy. Furthermore, because the walls 3n are not included in the second member 3Rr, if the second member 3Rr is to be made of a synthetic resin material that is softer (easily bent, deformed) than a metallic material, the stiffness of the housing 3A could be reduced. Because, in the first embodiment, the first member 3Fr is made of a synthetic resin material and the second member 3Rr is made of a metallic material, as an example, the housing 3A can be reduced in weight, while ensuring the stiffness and the strength of the housing 3A. Such a combination of the materials (properties of the materials) is merely an example, and other combinations of materials may also be used.

In the first embodiment, as an example, as illustrated in FIGS. 3 and 4, the display device 4 (a display module, a display, a panel, a display component) is housed in the housing 3A. Specifically, the display surface 4a (a display screen, a display, a first surface, an area, a portion, a region, a wall) of the display device 4 located on the side of the front surface 3a is exposed to the front side (outside) of the housing 3A through the opening 3r. The display device 4 comprises the display surface 4a and a rear surface 4d located opposite the display surface 4a. A user of the display can view the display surface 4a from the front side through the opening 3r. The display device 4 has an external appearance of a rectangular shape (in the first embodiment, an oblong shape, as an example) in the front view. The display device 4 also has a cuboid shape that is thin and flat in the front-back direction. The display device 4 is a liquid crystal display (LCD), an organic electro-luminescent display (GELD), or a plasma display panel (PDP), for example.

In the first embodiment, as an example, as illustrated in FIGS. 3 and 4, a transparent, relatively thin, and rectangular input operation panel 5 (as an example, a touch panel, a touch sensor, an operation surface) is provided to the front side (the frontal side, the side of the wall 3k) of the display device 4. The input operation panel 5 covers the display surface 4a. An operator (e.g., a user) can make inputs by making operations such as touching, pressing, rubbing the input operation panel 5, or moving a hand, a finger, or a stylus near the input operation panel 5. Light output from the display surface 4a of the display device 4 penetrates through the input operation panel 5 and travels toward the front side (outside) of the housing 3A through the opening 3r on the wall 3k. The input operation panel 5 is an example of an input module.

In the first embodiment, as an example, as illustrated in FIGS. 3 and 4, the display device 4 and the input operation panel 5 are supported by the first member 3Fr. Specifically, the display device 4 and the input operation panel 5 are fixed to the first member 3Fr with fixtures (fixing portions, clamps, e.g., screws, clamps, or portions, not illustrated), an adhesive (e.g., an adhesive agent, or double-sided adhesive tape, not illustrated), and the like. The display device 4 and the input operation panel 5 are fixed to the wall 3k or the wall 3n (the end 3n1 of the wall 3n). In the first embodiment, as an example, an end 32a (a surface, an end) of the first member 3Fr (the wall 3n of the first member 3Fr) that is located on the front side is laid along and continuously to a surface 5a (a front surface, a frontal surface) of the input operation panel 5. In the first embodiment, as an example, the front surface 3a of the wall 3k and the display surface 4a of the display device 4 are also laid continuously, and the front surface 3a and the display surface 4a are covered by the input operation panel 5.

In the first embodiment, as an example, as illustrated in FIGS. 3 and 4, a battery 6 (a cell, an assembled battery) and circuit boards 7 and 8 (a board, a printed board, a control board; the circuit board 8 is not illustrated in FIGS. 3 and 4) and the like that are electric components are housed behind the display device 4 (on the side closer to the rear surface 4d, behind side, back side, the side of the wall 3m, the opposite side of the display surface 4a) in the housing 3A. The electric components such as the battery 6, the circuit boards 7 and 8, and the display device 4 are electrically connected to each other via wiring (e.g., a cable, a flexible cable, and a flexible printed wiring board) not illustrated.

In the first embodiment, as an example, the battery 6 may be configured as a lithium-ion secondary battery. A lithium-ion secondary battery is a type of a non-aqueous electrolyte battery, and lithium ions in the electrolyte conduct electricity. Manganese, nickel, or iron phosphate is used as a cathode material, and an oxide material such as lithium titanium oxide (LTO) or a carbon material is used as an anode material. Used as electrolyte (an electrolyte solution, as an example) is an organic solvent, for example, such as ethylene carbonate or diethyl carbonate in which a lithium salt such as florin-based complex salt (LiBF4) is dissolved. In the first embodiment, as an example, the battery 6 is capable of supplying power that is required for enabling the television receiver 1A to operate, e.g., display videos and output sound, to the circuit boards 7 and 8, to the electric components in the housing 3A, such as the display device 4 and a speaker (not illustrated), and to the circuit boards 7 and 8. The battery 6 is also capable of supplying power to an external device connected to the circuit boards 7 and 8 via a connector and wiring, for example.

In the first embodiment, as an example, the battery 6 comprises a plurality of cells 61, 62, and 63, as illustrated in FIG. 1. The cells 61, 62, and 63 are electrically connected serially or in parallel. The cells 61, 62, and 63 are arranged side by side along the end 3c. In the first embodiment, as an example, the battery 6 comprises a circuit board 64. The electrodes (not illustrated) of the respective cells 61, 62, and 63 are connected (joined) to the circuit board 64 (conductor pattern of the circuit board 64), and, in this manner, the cells 61, 62, and 63 are integrated. Because the cells 61, 62, and 63 are integrated, production labors and costs can be reduced compared with a structure in which the cells 61, 62, and 63 are individually assembled. The circuit board 64 comprises a bus bar (a conductor, not illustrated) that electrically connects the circuit boards 7 and 8 to each of the cells 61, 62, and 63, or between the cells 61, 62, and 63, as an example. Electric components (not illustrated) are provided (implemented) to the circuit board 64. The electric components and the conductor pattern (wiring pattern not illustrated) on the circuit board 64 together form an electric circuit (an electronic circuit) that realizes a function for monitoring an output power (voltage), temperature, and the like of each of the cells 61, 62, and 63 or the battery 6, as an example.

Each of the cells 61, 62, and 63 is configured as an independent single cell comprising a chamber (an enclosure) in which an electrolyte (an electrolyte solution), electrodes, a separator, and the like are housed (enclosed). Each of the cells 61, 62, and 63 has a cuboid shape (a plate-like shape, a rectangular plate-like shape, a card-like shape) that is thin and flat in the thickness direction of the housing 3A (the Z direction). In the first embodiment, as an example, each of the cells 61, 62, and 63 are covered by an insulating, flexible, sheet-like covering (a skin, a film) that is the outmost layer, without any hard casing (a shell). Therefore, according to the first embodiment, as an example, because the battery 6 has no casing, the battery 6 (the cells 61, 62, and 63) can be reduced in size (thickness) and weight. Therefore, the housing 3A (the television receiver 1A) can be configured small (thin) and light-weighted. In the first embodiment, as an example, each of the cells 61, 62, and 63 is configured as a bag (a part) partitioned from the others. Therefore, as an example, a local stress applied to the battery 6, because of an external force and the like, can be reduced, compared with a structure in which the cells 61, 62, and 63 are firmly coupled integrally.

In the first embodiment, as an example, a plurality of components 9 (parts, elements, electronic components, electric components) such as a central processing unit (CPU) are implemented on at least one of the circuit boards 7 and 8. The components 9 include heating elements. A cooling mechanism (a heat radiator or a heat receiving element not illustrated) may be provided to an electronic component 9 (a heating element) that generates a large amount of heat. The circuit boards 7 and 8, the components 9, and the like form at least a part of a controlling circuit (not illustrated). The controlling circuit may comprise a video signal processing circuit, a tuner, a high-definition multimedia interface (HDMI) signal processor, an audio-video (AV) input terminal, a remote controller signal receiver, a controller, a selector, an on-screen display, a storage (e.g., a read-only memory (ROM), a random access memory (RAM), a hard disk drive (HDD)), an audio signal processing circuit, and the like. The controlling circuit controls video outputs (e.g., moving images or still images) from the display surface 4a of the display device 4, sound outputs from a speaker (not illustrated), and light emissions from a light emitting diode (LED) (not illustrated). The display device 4, the speaker, the LED, and the like are examples of an output module.

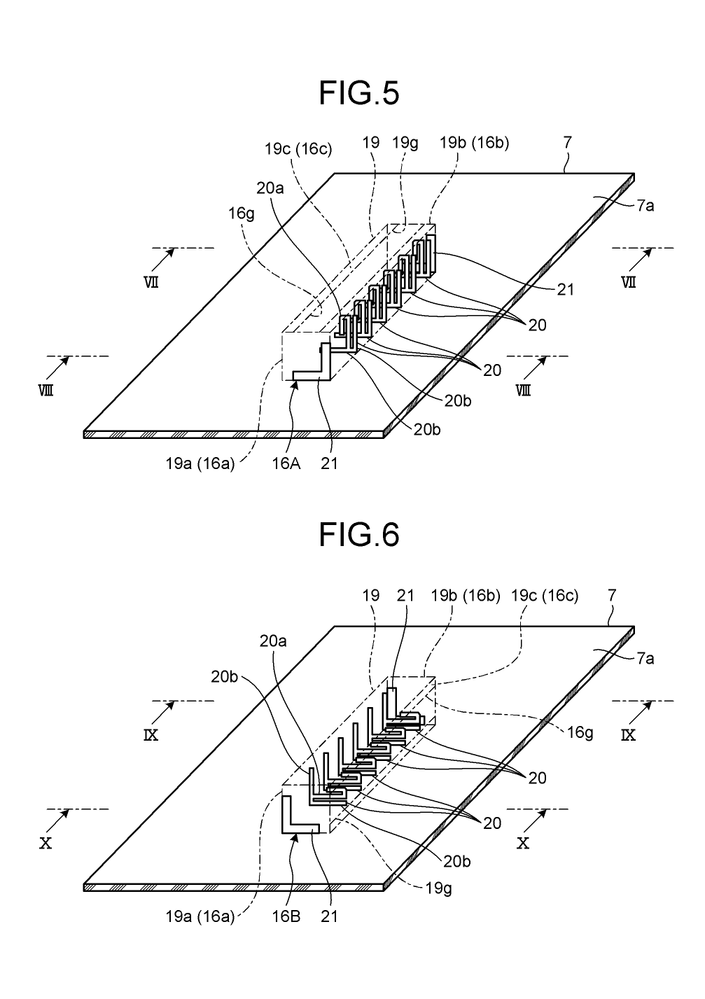

In the first embodiment, as illustrated in FIG. 4, a first connector 16A and a second connector 16B are provided to the mounting surface 7a of the circuit board 7 (a surface, one surface, a first surface) as connectors 16. FIG. 5 illustrates the first connector 16A, and FIG. 6 illustrates the second connector 16B. As illustrated in FIGS. 5 and 6, the first connector 16A and the second connector 16B have the same structure, but are mounted on the circuit board 7 in different orientations. The first connector 16A and the second connector 16B are housed in the housing 3A, electrically connected to the circuit board 7, and connected with external connectors 18 (connectors, counterpart connectors, the other connectors, another connectors). The first connector 16A and the second connector 16B are female connectors into which the respective external connectors 18 are inserted. Because the first connector 16A and the second connector 16B have the same structure, the structure of the first connector 16A will be explained below in detail.

As illustrated in FIGS. 5, 7 and 8, the first connector 16A has a side 16e that is implemented on the mounting surface 7a. The first connector 16A has an external appearance of a cuboid, as an example. The first connector 16A comprises an insulating member 19 (a body, a backbone member, a supporting member, a support, a holding member, a holding portion), a plurality of terminal members 20 (mounting portions, fixed portions, junctures, supports, supporting portions, connected portions, connection portions, continuous portions, concatenated portions, continuing portions, running portions, terminals, electrode members, electrodes), and a pair of (a plurality of) reinforcing members 21 (members, backbone members, frames, portions). The first connector 16A also comprises ends 16a and 16b in the longitudinal direction, and four sides 16c, 16d, 16e, and 16f connecting these two ends 16a and 16b. An opening 16g is formed on the side 16c, which is one of the sides 16c, 16d, 16e, and 16f. Each of the sides 16c, 16d, 16e, and 16f includes a part of the insulating member 19. Each of the sides 16c, 16d, 16e, and 16f may be colored differently to enable the sides 16c, 16d, 16e, and 16f to be easily distinguished.

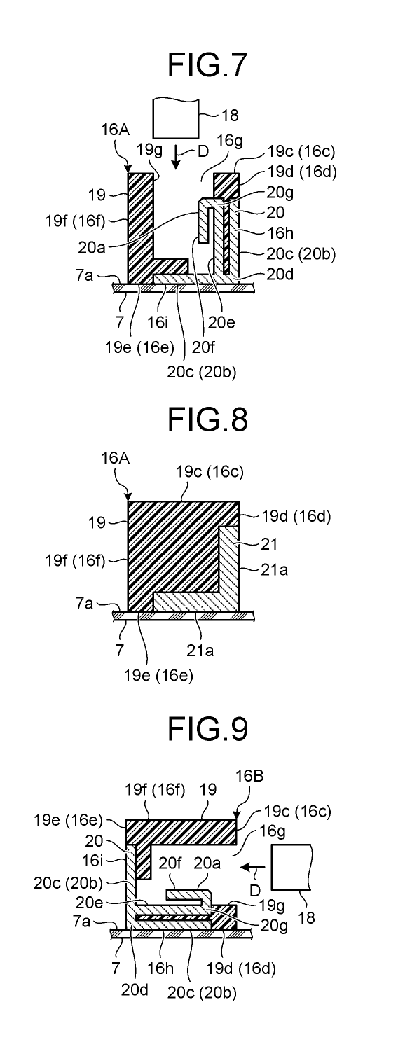

The insulating member 19 has an external appearance of a cuboid, as an example. The insulating member 19 comprises end surfaces (ends, parts) 19a and 19b in the longitudinal direction, and four side surfaces (sides, parts) 19c, 19d, 19e, and 19f connecting these two end surfaces 19a and 19b. The opening 16g is formed on the side surface 19c, which is one of the side surfaces 19c, 19d, 19e, and 19f. The insulating member 19 also comprises an insertion portion (a joining portion, a connected portion, an engaged portion, an engaging portion) 19g into which the external connector 18 is inserted. The arrow D in FIG. 7 indicates the direction in which the external connector 18 is inserted into the insertion portion 19g. The insertion portion 19g is recessed from the side surface 19c toward the side surface 19e. The opening 16g is formed on the side surface 19c of the insertion portion 19g. The insulating member 19 is made of an insulating material, and has an insulating property. An example of the insulating material includes resin.

Each of the terminal members 20 is made of copper alloy, as an example, with a surface plated with gold, silver tin, nickel, and the like, and has a conductive property. The terminal members 20 are formed on the insulating member 19 by insert molding or pressure molding, for example. The terminal members 20 are arranged in parallel (side by side) with each other on the insulating member 19 in a direction intersecting with a direction in which the external connector 18 is inserted into the insertion portion 19g. The direction intersecting with the direction in which the external connector 18 is inserted into the insertion portion 19g is, as an example, the longitudinal direction of the first connector 16A (the insulating member 19). The terminal members 20 are arranged to be spaced apart from each other. The terminal members 20 are arranged in a line, in parallel with each other. The terminal members 20 are aligned along one side of the circuit board 7, as an example.

As illustrated in FIG. 7, each of the terminal members 20 comprises a first terminal portion 20a (a juncture, a support, a supporting portion, a connected portion, a connection portion, a continuous portion, a concatenated portion, a continuing portion, a running portion, a terminal, an electrode), and two (a plurality of) second terminal portions 20b (mounting portions, fixed portions, junctures, supports, supporting portions, connected portions, connection portions, continuous portions, concatenated portions, continuing portions, running portions, terminal, electrodes). The first terminal portion 20a is electrically connected to the external connector 18 in the insertion portion 19g. The first terminal portion 20a is electrically connected to a terminal portion (not illustrated) of the external connector 18.

The second terminal portions 20b are provided to the respective different sides 16d and 16e. The second terminal portions 20b are electrically connected to the first terminal portion 20a, and face different directions from each other. Specifically, in the first embodiment, because connected surfaces (surfaces, one surfaces, connected portions, mounting portions, mounting surfaces, fixed surfaces, fixed portions, supports, supporting portions, connected portions, connection portions, continuous portions, concatenated portions, continuing portions, running portions) 20c on the respective second terminal portions 20b face different directions from each other, the second terminal portions 20b face different directions from each other. One of the connected surfaces 20c is laid along the direction in which the external connector 18 is inserted, and the other connected surface 20c is laid in a direction intersecting with the direction in which the external connector 18 is inserted. The one connected surface 20c is laid along the mounting surface 7a of the circuit board 7, and the other connected surface 20c is laid along a direction intersecting with the mounting surface 7a. The two second terminal portions 20b are arranged in an L-shape. The connected surfaces 20c are surfaces of the second terminal portions 20b facing opposite the insertion portion 19g, and are exposed from the insulating member 19. The connected surfaces 20c are arranged at different positions from the position of the insertion portion 19g. The connected surfaces 20c comprise the external surface of the first connector 16A. The connected surfaces 20c are surfaces that are each mountable onto the mounting surface 7a when the terminal members 20 are not implemented on the circuit board 7. In the first embodiment, the connected surface 20c of one of the two second terminal portions 20b in the terminal member 20 is implemented on the mounting surface 7a. The connected surface 20c is fixed to the mounting surface 7a with a solder (not illustrated), as an example. In this manner, in the first embodiment, one of the two (a plurality of) second terminal portions 20b of the terminal member 20 is electrically connected to the circuit board 7.

The two second terminal portions 20b are connected to each other. Each of the second terminal portions 20b has a stick-like shape (a linear shape, a shape having a longitudinal direction). The two second terminal portions 20b extend from a connected portion 20d at which the two second terminal portions 20b are connected in different directions from each other. The two second terminal portions 20b are connected at an approximately right angle. One of the second terminal portions 20b connected to the circuit board 7 is laid along the mounting surface 7a. Other one of the second terminal portions 20b, which is other than that connected to the circuit board 7, extends in a direction away from the mounting surface 7a.

The first terminal portion 20a comprises a first portion 20e and a second portion 20f. The first portion 20e extend from a position on one of the two second terminal portions 20b spaced apart from the connected portion 20d, in a direction along other one of the second terminal portion 20b. The second portion 20f is folded at a tip 20g of the first portion 20e toward an opposite side of the other one of the second terminal portions 20b, and is electrically connected to the external connector 18. The second portion 20f has a spring property.

The reinforcing members 21 are provided to the respective ends 16a and 16b, as illustrated in FIG. 5. The reinforcing members 21 are added to the insulating member 19 to reinforce the insulating member 19. Arranged between the pair of reinforcing members 21 are the terminal members 20. Each of the reinforcing members 21 comprises a plurality of fixed portion 21a. Each of the fixed portions 21a is arranged correspondingly to each of the second terminal portions 20b. Specifically, the fixed portions 21a are provided to the respective sides 16d and 16e, where the second terminal portions 20b are located. Each of the fixed portions 21a is provided along the corresponding second terminal portion 20b. Each of the fixed portions 21a has a stick-like shape. These two fixed portions 21a are connected to each other approximately at a right angle. One of the two (a plurality of) fixed portions 21a of the reinforcing member 21 is fixed to the circuit board 7. The fixed portion 21a is fixed to the mounting surface 7a of the circuit board 7 by a solder (not illustrated), as an example. The mounting surface 7a is the surface to which the first connector 16A is electrically connected. The reinforcing member 21 does not comprise an electric circuit.

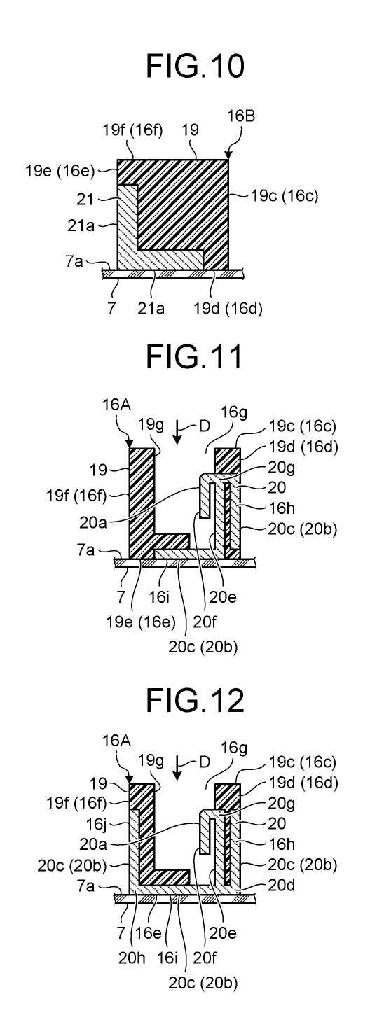

The first connector 16A explained above has a so-called straight angle implementation where the direction in which the external connector 18 is inserted into the insertion portion 19g is approximately perpendicular to the mounting surface 7a of the circuit board 7. The first connector 16A is located at the center of the circuit board 7, as an example (FIG. 4). The first connector 16A is also located between the components 9 implemented on the circuit board 7, as an example (FIG. 4). In other words, in the television receiver 1A, the first connector 16A implemented at a straight angle is used at the center of the circuit board 7 or between the components 9, as an example. By contrast, the second connector 16B illustrated in FIGS. 6, 9, and 10 has a so-called right angle implementation where the direction in which the external connector 18 is inserted into the insertion portion 19g is approximately in parallel with the mounting surface 7a of the circuit board 7. In the second connector 16B, the side 16d is implemented on the mounting surface 7a. The second connector 16B is located on an edge of the circuit board 7, as an example (FIG. 4). In other words, in the television receiver 1A, the second connector 16B implemented at a right angle is used on an edge of the circuit board 7, as an example.

In the first embodiment, the side 16d is an example of a first side, and the side 16e is an example of a second side. Each of the second terminal portions 20b formed on the side 16d comprises a first mounting portion 16h, and each of the second terminal portions 20b formed on the side 16e comprises a second mounting portion 16i. In the first connector 16A and the second connector 16B, one of the first mounting portion 16h and the second mounting portion 16i is electrically connected to the circuit board 7. In the first connector 16A, the second mounting portion 16i is electrically connected to the circuit board 7. In the second connector 16B, the first mounting portion 16h is electrically connected to the circuit board 7.

As may be understood from the explanation above, in the first embodiment, each of the first connector 16A (electronic component) and the second connector 16B (electronic component) comprises the ends 16d and 16e that can be coupled (connected, fixed) to the circuit board 7 (a first member), and one of the ends 16d and 16e is coupled to the circuit board 7 (a first member).

As explained above, in the first embodiment, each of the first connector 16A and the second connector 16B comprises the first mounting portion 16h and the second mounting portions 16i. Therefore, the first connector 16A and the second connector 16B may be implemented onto the circuit board 7 at two (a plurality of) orientations. Therefore, an implementation efficiency of the circuit board 7 can be improved. Therefore, in the television receiver 1A comprising the first connector 16A and the second connector 16B, an implementation efficiency of the circuit board 7 can be improved.

Furthermore, in the first embodiment, the components 9 (portions, elements, electronic components, electric components) such as a CPU may be implemented on the circuit board 7. The components 9 implemented on the circuit board 7 may be provided with a cooling mechanism, as an example. In the first embodiment, as an example, the first connector 16A implemented at a straight angle is used at the center of the circuit board 7 or between the components 9, and the second connector 16B implemented at a right angle is used on an edge of the circuit board 7. Therefore, even if the components 9 are implemented near the first connector 16A or the second connector 16B, the external connector 18 can be connected to the first connector 16A or the second connector 16B relatively easily.

In the first embodiment, the circuit board 7 is used as an example of the first member, and the first connector 16A and the second connector 16B are used as examples of electronic components; however, embodiments are not limited thereto. For example, as the first member and the electronic component, the electronic component may be any electronic component comprising a plurality of sides that can be coupled to the first member, and in which one of the sides is connected to the first member. The first member may also be an internal wall of a housing or a side surface of a component. The electronic component may also be an antenna, a capacitor, or a socket, for example.

A modification of the first embodiment will now be explained. As illustrated in FIG. 11, in a first connector 16A according to the modification, the two second terminal portions 20b are connected via the first terminal portion 20a. The second terminal portion 20b provided to the side 16d is connected to the tip 20g of the first terminal portion 20a.

In a second embodiment, as illustrated in FIG. 12, the terminal member 20 comprises another second terminal portion 20b provided to the side 16f, in addition to the two second terminal portions 20b provided to the ends 16d and 16e, respectively. The additional second terminal portion 20b provided to the side 16f extends from an end 20h of one of the two second terminal portions 20b provided to one of the ends 16d and 16e (i.e., one of the two terminal portions 20b on the side 16e). Here, the end 20h is opposite the connected portion 20d. The second additional terminal portion 20b extends along other one of the second terminal portions 20b (i.e., other one of the two terminal portions 20b on the side 16d). The second terminal portion 20b provided to the side 16f comprises a third mounting portion 16j.

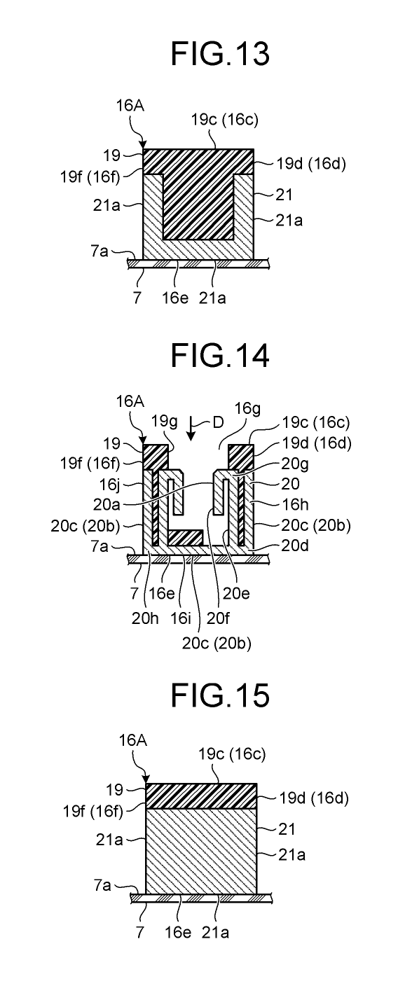

As illustrated in FIG. 13, the reinforcing member 21 has the fixed portion 21a provided to the side 16f, in addition to the two fixed portions 21a provided to the ends 16d and 16e, respectively. The reinforcing member 21 comprises a general U shape.

In the second embodiment explained above, the first connector 16A comprises the first mounting portion 16h, the second mounting portions 16i, and the third mounting portion 16j. Therefore, the first connector 16A can be implemented onto the circuit board 7 at a plurality of orientations. Therefore, an implementation efficiency of the circuit board 7 can be improved.

A modification of the second embodiment will now be explained. As illustrated in FIG. 14, the first connector 16A according to the modification comprises two first terminal portions 20a. The two first terminal portions 20a extend from the second terminal portion 20b provided to the side 16e. These first terminal portions 20a are connected to a connection terminal of the external connector 18. These first terminal portions 20a sandwich the external connector 18 therebetween. As illustrated in FIG. 15, the reinforcing member 21 has a rectangle shape, and the reinforcing member 21 comprises three fixed portions (fixed surfaces) 21a.

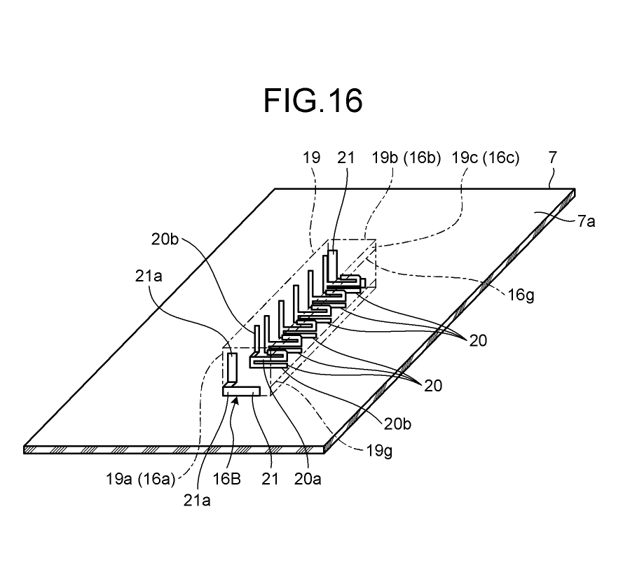

As illustrated in FIG. 16, in a third embodiment, the terminal member 20 comprises two (a plurality of) second terminal portions 20b that are positioned offset from each other in the direction in which the terminal members are aligned. As an example, in third embodiment, one of the terminal members 20 (the terminal member 20 on the front side in FIG. 16) comprises two (a plurality of) second terminal portions 20b that are positioned offset from each other in the direction in which the terminal members 20 are aligned (the longitudinal direction of the insulating member 19). One of a pair of the reinforcing members 21 comprises the two fixed portions 21a that are also positioned offset from each other in the direction in which the terminal members 20 are aligned (the longitudinal direction of the insulating member 19).

In the third embodiment explained above, because the terminal member 20 comprises the two (a plurality of) second terminal portions 20b that are positioned offset from each other in the direction in which the terminal members 20 are aligned (the longitudinal direction of the insulating member 19), the first connector 16A can be suppressed from being implemented on the circuit board 7 at a wrong orientation.

In the third embodiment and the second embodiment, the components 9 (portions, elements, electronic components, electric components) such as a CPU may be implemented on the circuit board 7, in the same manner as in the first embodiment. The components 9 implemented on the circuit board 7 may be provided with a cooling mechanism, as an example. In the third embodiment, as an example, the first connector 16A implemented at a straight angle is used at the center of the circuit board 7 or between the components 9, and the second connector 16B implemented at a right angle is used on an edge of the circuit board 7. Therefore, even if the components 9 are implemented near the first connector 16A or the second connector 16B, the external connector 18 can be connected to the first connector 16A or the second connector 16B relatively easily.

An electronic device 1B according to a fourth embodiment is a personal computer, a television receiver, a smartphone, a smartbook, a cellular phone, a PDA, or the like, such as a so-called slate-type or a tablet type display device having a function of software keyboard.

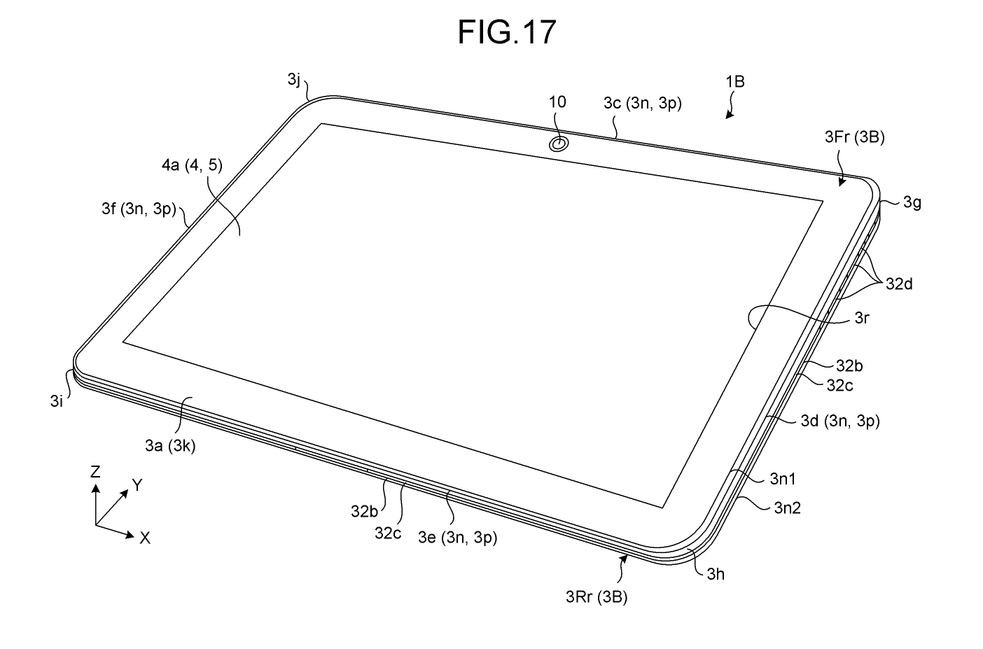

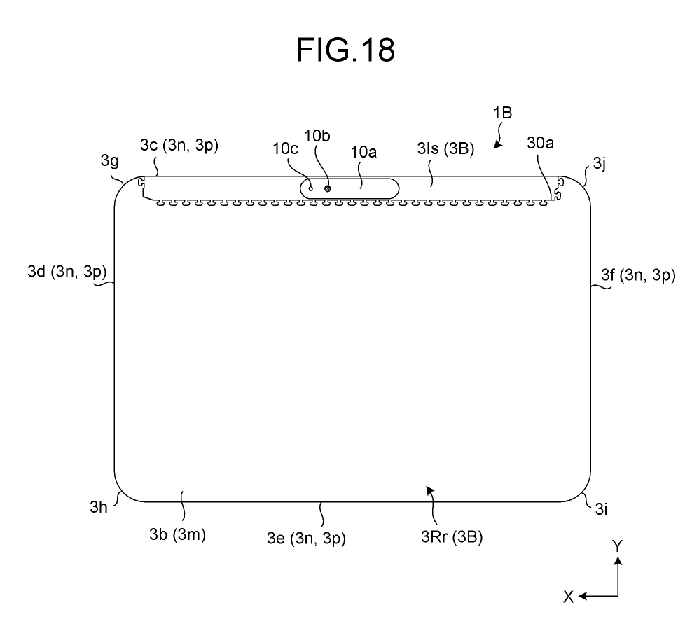

In the fourth embodiment, as an example, as may be understood from FIGS. 17 and 18, a housing 3B of the electronic device 1B has an external appearance of a rectangular shape (in the fourth embodiment, an oblong shape, as an example) in the front view and the rear view. The housing 3B is also in a cuboid shape that is thin and flat in the front-back direction (the thickness direction of the housing 3B, the Z direction). The housing 3B comprises a front surface 3a (a frontal surface, a surface, a surface portion) and a rear surface 3b (a back surface, a surface, a surface portion) located opposite the front surface 3a. The front surface 3a and the rear surface 3b are laid approximately in parallel (in the fourth embodiment, in parallel, as an example). The housing 3B also comprises four ends 3c to 3f (sides, edge portions) and four corners 3g to 3j (pointed portions, curved portions, ends) in the front view. The ends 3c and 3e are examples of longer sides. The ends 3d and 3f are examples of shorter sides.

The housing 3B comprises a wall 3k (a portion, a plate, a frame, a front wall, a frontal wall, a top wall) including the front surface 3a, and a wall 3m (a portion, a plate, a rear wall, a back wall, a bottom wall, a second wall) including the rear surface 3b. Each of the walls 3k and 3m has a rectangular shape (in the fourth embodiment, an oblong shape, as an example). The housing 3B comprises four walls 3n (portions, plates, side walls, end walls, standing walls, stretched portions, first walls) each of which includes a side surface 3p (a surface, a circumferential surface) and stretches across the wall 3k and the wall 3m. An opening 3r having a rectangular shape, as an example, is formed on the wall 3k.

The housing 3B may be made from a combination of a plurality of parts (divided portions). The housing 3B comprises a first member 3Fr (a first portion, a front side member, a cover, a bezel, a frame) including at least the wall 3k, and a second member 3Rr (a second portion, a rear side member, a base, a bottom, a plate) at least including the wall 3m, as an example. In the fourth embodiment, the walls 3n are basically configured as a portion of the first member 3Fr. In other words, each of the walls 3n stretches across an end 3n1 (one end, a front end, the front surface 3a) located on the side of the opening 3r in the thickness direction of the housing 3B and an end 3n2 (the other end, a rear end, the rear surface 3b) located opposite the end 3n1 (see FIG. 17), and covers the circumference of the display device 4 (the side surface 4b). The walls 3n are thicker than the other walls 3k and 3b. Therefore, the stiffness and the strength in the thickness direction of the housing 3B can be increased easily.

In the fourth embodiment, as an example, the first member 3Fr is made of a synthetic resin material, and the second member 3Rr is made of a metallic material. Therefore, according to the fourth embodiment, the weight of the housing 3B can be reduced while ensuring the stiffness and the strength of the housing 3B, in the same manner as in the first embodiment. Such a combination of the materials (properties of the materials) is merely an example, and other combinations of materials may also be used.

As illustrated in FIG. 17, a groove 32b extending along the ends 3c to 3f is formed in the middle (at the center) of the thickness direction of the outer surface of the walls 3n. A member 32c extending along the groove 32b is enclosed (embedded) in at least a part of the groove 32b. The walls 3n and the member 32c may be made of different materials or have different colors. By configuring the member 32c as a member harder than the walls 3n, as an example, the walls 3n is reinforced. By contrast, by configuring the member 32c as a member that is softer than the walls 3n (as an example, a flexible member), the bendability (flexibility) of the walls 3n is increased, and the member 32c can absorb impacts better, as an example. In a part of the groove 32b, an operation module 32d such as a switch may be provided, instead of the member 32c. Examples of the switch for the operation module 32d include a power switch, a volume control switch, and a reset switch. The member 32c and the operation module 32d may protrude from the walls 3n by the same height. Such a configuration can make the operation module 32d visually less prominent. Furthermore, because the member 32c and the operation module 32d are provided continuously, aesthetic quality can be improved.

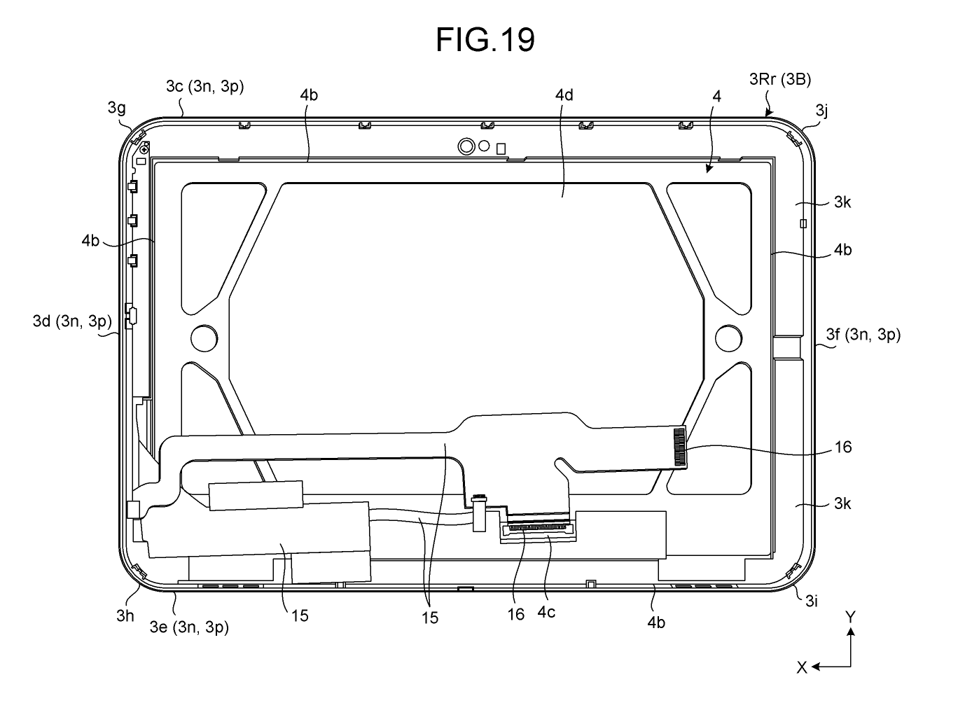

In the fourth embodiment, as an example, as illustrated in FIGS. 17 and 19, the display device 4 (a display module, a display, a panel, a display component) is housed in the housing 3B. Specifically, the display surface 4a of the display device 4 located on the side of the front surface 3a is exposed to the front side (outside) of the housing 3B through the opening 3r. A user can view the display surface 4a from the front side through the opening 3r. The display device 4 has an external appearance of a rectangular shape (in the fourth embodiment, an oblong shape, as an example) in the front view. The display device 4 has a cuboid shape that is thin and flat in the front-back direction. The display device 4 is a LCD, an GELD, or a PDP, for example. In the fourth embodiment, as an example, a transparent, relatively thin, and rectangular input operation panel 5 (as an example, a touch panel, a touch sensor, an operation surface) is provided to the front side (the frontal side, the side of the wall 3k) of the display device 4, in the same manner as in the first embodiment. In the fourth embodiment, the display device 4 and the input operation panel 5 are supported by the first member 3Fr, in the same manner as in the first embodiment.

In the fourth embodiment, as an example, as illustrated in FIGS. 19 to 21, as electric components, the battery 6 (a cell, an assembled battery), the circuit board 7 (a circuit board, a printed board, a control board), a camera module 10 (a camera unit, a camera assembly, an image capturing device), a speaker module 11 (a speaker unit, a speaker assembly, an audio output device), a connector module 12 (a connector unit, a connector assembly, a connector device), an antenna module 13 (an antenna unit, an antenna assembly, an antenna device), an oscillation generating module 14 (a motor having a rotating shaft to which an eccentric weight is attached), and the like are housed behind the display device 4 (on the side of the rear surface 4b, behind side, back side, the side closer to the wall 3m, on the opposite side of the display surface 4a) in the housing 3B. These electric components are electrically connected to the other electric components via wiring 15 (e.g., a cable, a flexible cable, a flexible printed wiring board).

In the fourth embodiment, as an example, the battery 6 may be configured as a lithium-ion secondary battery. In the fourth embodiment, as an example, the battery 6 is capable of supplying power that is required for enabling the electronic device 1B to operate, e.g., display videos and output sound, to the display device 4 and electric components installed in the housing 3B via the connector 16 and the wiring 15, for example. The battery 6 is also capable of supplying power to an external device connected to the circuit board 7 and the like via the connector 16 and the wiring 15, for example.

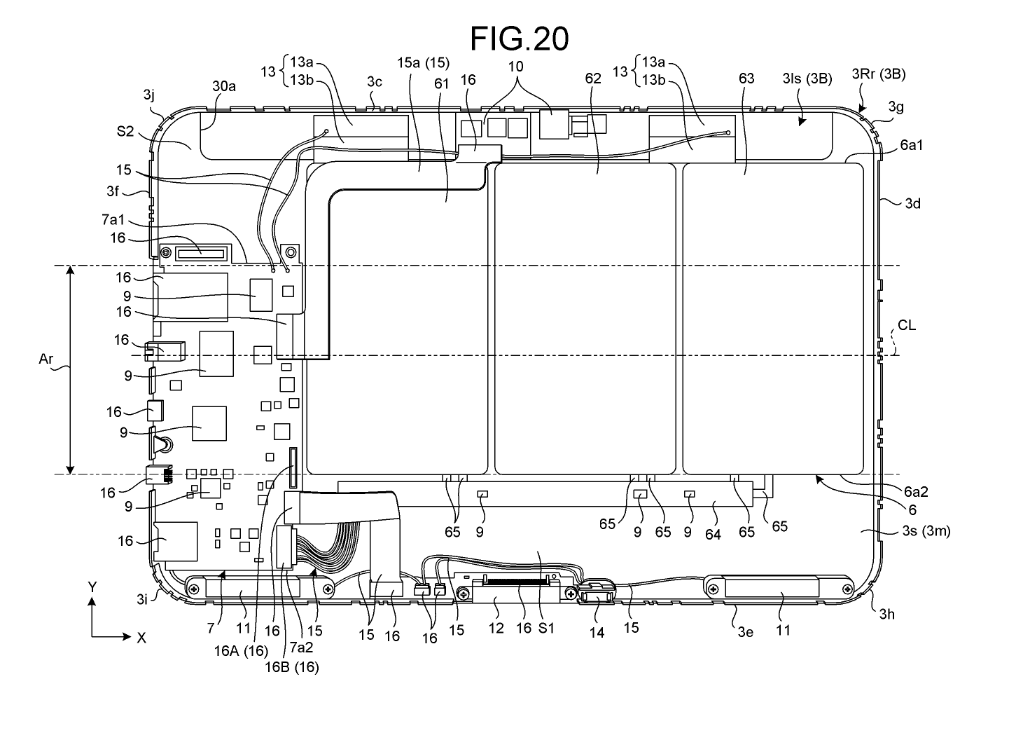

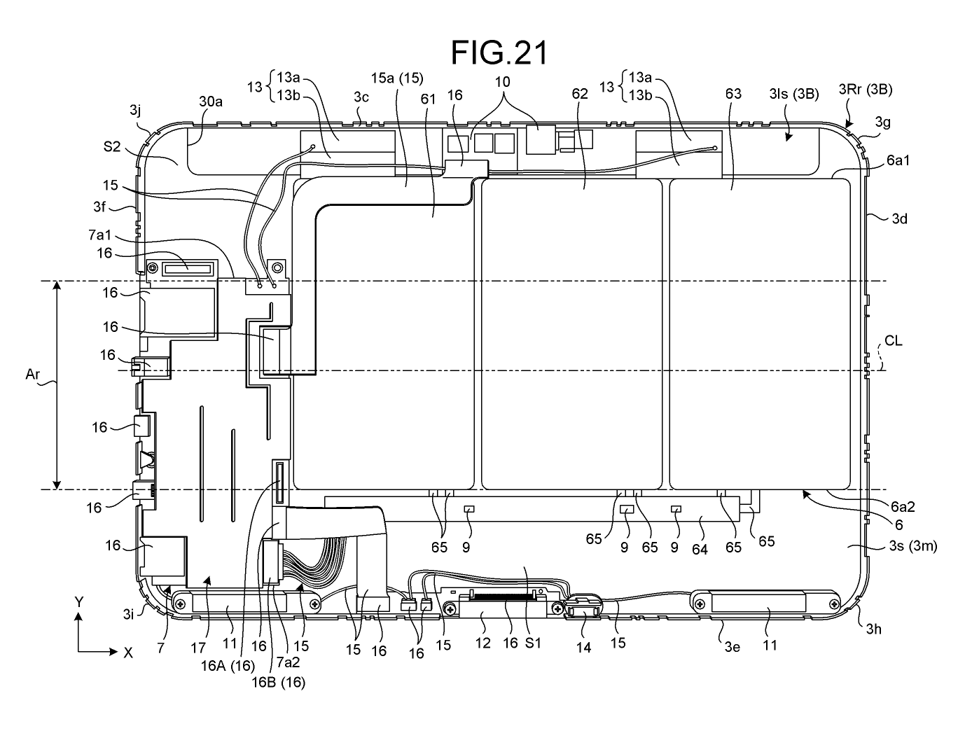

In the fourth embodiment, as an example, the battery 6 comprise a plurality of cells 61, 62, and 63, as illustrated in FIGS. 20 and 21. The cells 61, 62, and 63 are arranged side by side along the end 3c. In the fourth embodiment, as an example, the battery 6 comprises a circuit board 64. Electrodes 65 of the respective cells 61, 62, and 63 are connected (joined) to the circuit board 64 (conductor pattern of the circuit board 64), and in this manner, the cells 61, 62, and 63 are integrated. Because the cells 61, 62, and 63 are integrated, production labors and costs can be reduced compared with a structure in which the cells 61, 62, and 63 are individually assembled. The circuit board 64 comprises a bus bar (a conductor) that electrically connects the circuit board 7 to each of the cells 61, 62, and 63, or between the cells 61, 62, and 63, as an example. The components 9 are provided (implemented) to the circuit board 64. The components 9 and the conductor pattern (wiring pattern not illustrated) on the circuit board 64 together form an electric circuit (an electronic circuit) that realizes a function of monitoring an output power (voltage), temperature, and the like of each of the cells 61, 62, and 63 or the battery 6, as an example.

In the fourth embodiment, as an example, the components 9 such as a CPU, a graphic controller, power circuit components, a platform controller hub (PCH), a memory slot connector, a LCD connector, an input/output (I/O) connector, a power coil, an element, a connector, and the like can be implemented on the circuit board 7. The components 9 include heating elements. A cooling mechanism 17 (a cooling mechanism) may be provided to the circuit board 7 (the components 9 on the circuit board 7).

In the fourth embodiment, as an example, the circuit board 7 and the components 9 format least a part of a controlling circuit (not illustrated). The controlling circuit may include a video signal processing circuit, a tuner, an HDMI signal processor, an AV input terminal, a remote controller signal receiver, a controller, a selector, an on-screen display, a storage (e.g., a ROM, a RAM, an HDD), an audio signal processing circuit, and the like. The controlling circuit controls video outputs (e.g., moving images or still images) from the display surface 4a of the display device 4, sound outputs from a speaker (not illustrated), and light emissions from a light emitting diode (LED) (not illustrated). The display device 4, the speaker, the LED, and the like are examples of an output module.

In the fourth embodiment, as an example, as illustrated FIGS. 19 to 21, the battery 6 and the circuit board 7 are not arranged overlapping each other in the thickness direction of the housing 3B (Z direction), and are laid along an internal surface 3s (a first surface) of the wall 3m in the housing. Therefore, the housing 3B can be configured thinner, compared with a structure in which the battery 6 and the circuit board 7 are overlapped each other in the thickness direction. In the fourth embodiment as well, the surface (a second surface, not illustrated) of the battery 6 facing the surface 3s of the wall 3m and the surface (a second surface, not illustrated) of the circuit board 7 are adhered (attached), at least partially, to the surface 3s using an adhesive agent, a double-sided adhesive tape, or the like, in the same manner as in the first embodiment. Therefore, in the fourth embodiment as well, the same advantageous effects of the first embodiment achieved because the electric components such as the battery 6 and the circuit board 7 are adhered to the wall 3m of the housing 3B can also be achieved.

Furthermore, as an example, on both sides of the center (the central line CL; see FIGS. 20 and 21) of the wall 3m, the surface of the battery 6 and the surface of the circuit board 7 facing surface 3s are adhered to the wall 3m. Preferably, relatively wide areas of these surfaces, and more preferably, from an end 6a1 of the surface of the battery 6 and an end 7a1 of the surface of the circuit board 7 facing surface 3s on the side of the end 3c to an end 6a2 and an end 7a2 on the side of the end 3e are adhered to the wall 3m. Therefore as an example, the wall 3m can be suppressed from being bent locally. Furthermore, in the fourth embodiment, as an example, the battery 6 is positioned closer to the end 3c (a second end), and the circuit board 7 is positioned closer to the end 3e (a first end). Therefore, as an example, a wider area of the wall 3m between the end 3c and the end 3e can be reinforced. Furthermore, as an example, an area S1 between the battery 6 and the end 3e and an area S2 between the circuit board 7 and the end 3c may be utilized better for laying other circuit boards (e.g., a driver circuit board 4c for the display device 4; see FIG. 19) or the wiring 15. Furthermore, in the fourth embodiment, as an example, the battery 6 and the circuit board 7 are arranged in a manner interspaced from the end 3c and the end 3e. Therefore, according to the fourth embodiment, as an example, the ends 3c and 3e where a hand or a finger can easily touch can be prevented from being heated by the heat generated by the battery 6 or the circuit board 7. Moreover, as may be obvious from FIG. 20, in the fourth embodiment, as an example, an area Ar to which the electric components are adhered is laid at the central part of the wall 3m including the central line CL, from one side (the side of the end 3d) to the other side (the side of the end 3f) of a direction laid along the ends 3c and 3e. Therefore, according to the fourth embodiment, as an example, the stiffness and the strength of the wall 3m of the second member 3Rr, and the stiffness and the strength of the housing 3B in turn, can be improved.

In the fourth embodiment, as an example, as illustrated in FIG. 20, a U-shaped cutout 30a is formed on the end 3c of the second member 3Rr. A third member 3Is made of a low-conductive material (a non-conductive material, an insulating material; e.g., a synthetic resin material) is attached to the cutout 30a. The third member 3Is is coupled to the cutout 30a on the wall 3m of the second member 3Rr by heat welding, for example.

In the fourth embodiment, as an example, as illustrated in FIG. 20, the antenna module 13 and the camera module 10 are attached to the third member 3Is made of a low-conductive material. In such a structure, because the conductive material functions as an electromagnetic shield, communications performed via the antenna module 13 can be prevented from being affected. On the side of the rear surface 3b, a cover (a plate) 10a is arranged as illustrated in FIG. 20, and a lens 10b and a light 10c of the camera module 10 are exposed through the cover 10a.

In the fourth embodiment, as an example, as illustrated in FIG. 20, the antenna module 13 comprises a communication module 13a and a grounding module 13b. A portion of the grounding module 13b is held between the battery 6 and the wall 3m of the second member 3Rr. By electrically connecting the grounding module 13b to the wall 3m, the electric potential of the wall 3m can be brought closer to the ground level (electric potential) of the grounding module 13b more easily. Therefore, the grounding module 13b can reduce noise introduced to the antenna module 13. In addition, the electric potential of the covering of the battery 6 can be brought closer to the ground level (electric potential) of the grounding module 13b in the antenna module 13 more easily.

In the fourth embodiment, as an example, as illustrated in FIG. 20, wiring 15a (15) electrically connected to the camera module 10 is configured as a flexible printed wiring board, and is laid over the battery 6 in the thickness direction of the housing 3B. Therefore, according to the fourth embodiment, as an example, the wiring 15a functions as an electromagnetic shield and can suppress communications performed via the antenna module 13 from being affected. Furthermore, in the fourth embodiment, as an example, as illustrated in FIG. 20, the wiring 15a is laid along the edge of the battery 6. Therefore, according to the fourth embodiment, the wiring 15a can be laid at a position offset from the center of the battery 6 where temperature could be high, as an example.

In the fourth embodiment, as an example, as illustrated in FIGS. 20 and 21, the first connector 16A and the second connector 16B are provided to the circuit board 7. The first connector 16A and the second connector 16B are mounted on the edge (an end, a side portion) of the circuit board 7. The first connector 16A and the second connector 16B are arranged along an edge of the cooling mechanism 17 (FIG. 21). The first connector 16A is arranged near a corner of the battery 6. The second connector 16B is arranged at a position adjacent to the speaker module 11. Another connector 16 is disposed between the first connector 16A and the second connector 16B. The second connector 16B is positioned in a space on a side of the circuit board 7 where the battery 6 is not present, as an example (FIG. 21). In this manner, an external connector can be connected to the first connector 16A from the side of the circuit board 7. By contrast, the first connector 16A is positioned in a region of the circuit board 7 where the battery 6 is present nearby, as an example (FIG. 21). In this manner, the battery 6 can be provided to a side of the circuit board 7, while enabling the external connector to be connected to the second connector 16B.

The electronic device 1B according to the fourth embodiment can also achieve the same advantageous effects as those achieved by having a structure that is similar to that of the television receiver 1A according to the first embodiment.

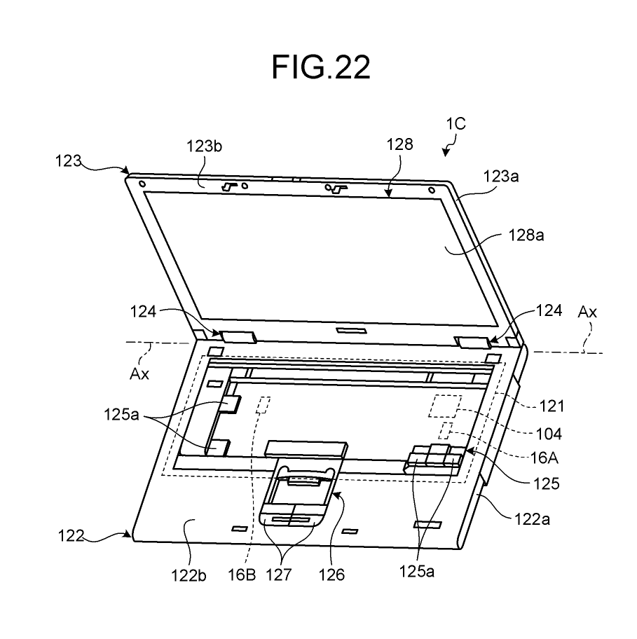

An electronic device 1C according to a fifth embodiment illustrated in FIG. 22 is configured as a so-called laptop personal computer. The electronic device 1C comprises a first main body 122 having a flat and rectangular shape and a second main body 123 having a flat and rectangular shape. The first main body 122 and the second main body 123 are connected via a hinge mechanism 124, in a manner rotatable with respect to each other about a rotation axis Ax between an opened configuration illustrated FIG. 22 and a folded configuration not illustrated.

On the first main body 122, a keyboard 125, a pointing device 126, a click button 127, and the like as input operation modules are arranged in a manner exposed from a front surface 122b that is an external surface of a housing 122a. To the second main body 123, a display 128 as a display device (a component) is provided in a manner exposed from a front surface 123b that is an external surface of a housing 123a. The display 128 is configured as an LCD, for example. While the electronic device 1C is opened, the keyboard 125, the pointing device 126, the click button 127, a display surface 128a of the display 128, and the like are exposed so that the user can use. While the electronic device 1C is folded, the front surface 122b and the front surface 123b closely face each other, and the keyboard 125, the pointing device 126, the click button 127, the display 128, and the like are hidden by the housing 122a and the housing 123a. In FIG. 22, only some of keys 125a of the keyboard 125 are illustrated.

Then, a circuit board 121 similar to the circuit board 7 of the first embodiment is housed in the housing 122a of the first main body 122 or in the housing 122a of the first main body 122 (in the present embodiment, only inside the housing 122a). Here, the first connector 16A and the second connector 16B are mounted to the circuit board 121.

The display 128 receives a display signal from a controlling circuit comprising a CPU 104 implemented on the circuit board 121, and displays an image such as a still image or a moving image. The controlling circuit in the electronic device 1C also comprises storages (e.g., a ROM, a RAM, and an HDD), interface circuits, and various controllers, in addition to the CPU 104. A speaker (not illustrated) and the like for outputting sound is also internalized in the electronic device 1C.

The electronic device 1C according to the fourth embodiment can also achieve the same advantageous effects as those achieved by having a structure that is similar to that of the television receiver 1A according to the first embodiment.

As explained above, according to each of the embodiments, an implementation efficiency of the circuit board can be improved.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. For example, in the examples explained in each of the embodiments, a connector is enabled to be connected (fixed, coupled) to a board at a plurality of orientations, but embodiments are not limited thereto.

What is claimed is:

1. A television receiver comprising:
a housing;
a display in the housing comprising a display surface and a rear surface;
a circuit board in the housing configured to be positioned on a side of the rear surface of the display; and
a connector in the housing and configured to be electrically connected to the circuit board, and to which an external connector is connected, wherein
the connector comprises:
an insulating member comprising an insertion portion into which the external connector is inserted;
a plurality of terminal members configured to be provided in parallel with the insulating member in a direction intersecting with a direction in which the external connector is inserted into the insertion portion;
a first terminal portion included in each of the terminal members, and configured to be electrically connected to the external connector in the insertion portion; and
a plurality of second terminal portions included in each of the terminal members, configured to be electrically connected to the first terminal portion, and configured to point different directions from each other, and wherein
one of the second terminal portions of each of the terminal members is configured to be electrically connected to the circuit board.

2. The television receiver of claim 1, wherein
the connector comprises a plurality of sides comprising a portion of the insulating member, and
the second terminal portions are configured to be provided to the sides that are different from each other.

3. The television receiver of claim 1, wherein
two of the second terminal portions are configured to be connected to each other,
each of the second terminal portions is configured to have a stick-like shape, and
the two second terminal portions are configured to extend from a connected portion at which the two second terminal portions are connected to each other, toward directions different from each other.

4. The television receiver of claim 3, wherein the first terminal portion comprises a first portion configured to extend from a position on one of the two second terminal portions spaced apart from the connected portion, along the other one of the two second terminal portions.

5. The television receiver of claim 4, wherein the first terminal portion comprises a second portion configured to be folded at a tip of the first portion toward an opposite side of the other one of the second terminal portions, the second portion being electrically connected to the external connector.

6. The television receiver of claim 3, further comprising another second terminal portion, in addition to the two second terminal portions, configured to extend from an end of one of the two second terminal portions opposite the connected portion, along the other one of the second terminal portions.

7. The television receiver of claim 1, further comprising a pair of reinforcing members comprising a plurality of fixed portions provided correspondingly to the second terminal portions, the reinforcing members being provided to the insulating member, the terminal members being configured to be provided between the reinforcing members, wherein
one of the fixed portions of each of the reinforcing members is configured to be fixed to the circuit board.

8. The television receiver of claim 7, wherein the fixed portions are configured to be provided along the second terminal portions, respectively.

9. The television receiver of claim 1, wherein the second terminal portion of the terminal member is positioned offset from another second terminal portion in a direction in which the terminal member is aligned.

10. The television receiver of claim 1, wherein
the circuit board comprises a mounting surface configured to be electrically connected with the connector, and
the one of the second terminal portions connected to the circuit board is configured to extend along the mounting surface, and the other one of the second terminal portions is configured to extend in a direction away from the mounting surface.

11. An electronic device comprising:
a circuit board; and
a connector comprising a first side provided with a first mounting portion and a second side provided with a second mounting portion, one of the first mounting portion and the second mounting portion being electrically connected to the circuit board.

12. An electronic device comprising:
a first member; and
an electronic component comprising a plurality of sides capable of being coupled to the first member, one of the sides being coupled to the first member.
